(19) United States
(12) Patent Application Publication
(10) Pub. No.: US 2025/0103594 A1
(43) Pub. Date: Mar. 27, 2025

(54) CARDINALITY-BASED INDEX CACHING OF TIME SERIES DATA

(71) Applicant: VMware, Inc., Palo Alto, CA (US)

(72) Inventors: Manoj RAMAKRISHNAN, Carmel, CA (US); Rourke RABINOWITZ, Atlanta, GA (US)

(73) Assignee: VMware, Inc., Palo Alto, CA (US)

(21) Appl. No.: 18/372,799

(22) Filed: Sep. 26, 2023

(51) Int. Cl. G06F 16/2455; G06F 16/242

(52) U.S. Cl. CPC G06F 16/24552; G06F 16/2425

(57) ABSTRACT

In a computer-implemented method for cardinality-based index caching of time series data, a cardinality of an index of a time series data monitoring system is determined. The cardinality of the index is compared to a cardinality threshold. Responsive to determining that the cardinality of the index exceeds the cardinality threshold, the index is cached in a local memory cache of a query node of the times series data monitoring system. Responsive to determining that the cardinality of the index does not exceed the cardinality threshold, the index is cached in a distributed memory cache of the times series data monitoring system.

### BACKGROUND

Management, monitoring, and troubleshooting in dynamic environments, both cloud-based and on-premises products, is increasingly important as the popularity of such products continues to grow. As the quantities of time-sensitive data grow, conventional techniques are increasingly deficient in the management of these applications. Conventional techniques, such as relational databases, have difficulty managing large quantities of data and have limited scalability. Moreover, as monitoring analytics of these large quantities of data often have real-time requirements, the deficiencies of reliance on relational databases become more pronounced.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 is a block diagram illustrating a system for managing data including ingestion of the time series data and processing queries of the time series data, in accordance with embodiments.

FIG. 2 is a block diagram illustrating an example ingestion node for ingesting data points of time series data, in accordance with embodiments.

FIG. 3 is a block diagram illustrating an example query node for responding to a query regarding time series data, in accordance with embodiments.

FIG. 4 is a block diagram of an example computer system upon which embodiments of the present invention can be implemented.

FIGS. 5 through 7 depict example flow diagrams of processes for cardinality-based index caching of time series data, according to various embodiments.

### DETAILED DESCRIPTION OF CERTAIN EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “receiving,” “determining,” “comparing,” “caching,” “storing,” “generating,” “clearing,” “forwarding,” “performing,” “updating,” “processing,” “writing,” “refreshing,” or the like, refer to the actions and processes of an electronic computing device or system such as: a host processor, a processor, a memory, a cloud-computing environment, a hyper-converged appliance, a software defined network (SDN) manager, a system manager, a virtualization management server or a virtual machine (VM), among others, of a virtualization infrastructure or a computer system of a distributed computing system, or the like, or a combination thereof. The electronic device manipulates and transforms data represented as physical (electronic and/or magnetic) quantities within the electronic device's registers and memories into other data similarly represented as physical quantities within the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example mobile electronic device described herein may include components other than those shown, including well-known components.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Example embodiments described herein improve the performance of computer systems by providing cardinality-based multi-tier index caching of time series data. In various embodiments, a computer-implemented method for cardinality-based index caching is provided. Cardinality of an index of a time series data monitoring system is determined. Cardinality is number of unique values available to be analyzed and queried in an index. Data of high cardinality and high dimensionality is granular data having a high amount of unique values available to be analyzed and queried. The cardinality of the index is compared to a cardinality threshold. Responsive to determining that the cardinality of the index exceeds the cardinality threshold, the index is cached in a local memory cache of a query node of the times series data monitoring system. Responsive to determining that the cardinality of the index does not exceed the cardinality threshold, the index is cached in a distributed memory cache of the times series data monitoring system.

Time series data can provide powerful insights into the performance of a system. The monitoring and analysis of time series data can provide large amounts of data for analysis. Time series data is indexed by time series data monitoring systems so that query processing time is fast with minimal latency. For observability use cases, these queries typically include a metric's name and/or tag (or label) key values and/or source or host values. Queries could also be reverse looked up starting from a tag/source alone without a metric name to query all matching metrics. Time series data monitoring systems typically maintain multiple indices, e.g., metric to hosts (reporting them), metrics to tags and tag to hosts (reporting them), and metrics emitted by a host, so as to support different types of lookup queries. For metrics specifically in the observability space (other than log/traces), these indices can become very high cardinality (e.g., run into the millions) if a user intentionally maintains tags (e.g., userId which is very cardinality) or unintentionally maintains as an example hosts (e.g., a pod name in Kubernetes deployment environments) where hosts (and their names/UUIDs) can change rapidly when deployments are rolled out every day or hours or days. Indices for that metric might reach into millions, e.g., if a http status code count metric has 30 services, 30 pods each, environment (dev/staging/prod) and region. 30 pods*30 services*4 environments*(dev/staging/prod)*4 regions*1000 Users.

Conventionally, time series data monitoring systems usually store these indices within an external memory cache (or disk) so query planning can resolve the user's query filters into relevant time series to fetch the data from disk or cold storage and perform statistical aggregation functions. In such conventional implementations, the performance of queries can rapidly deteriorate after a certain size of cardinality per read index value. This read from the external memory cache can get slow (e.g., milliseconds versus nanosecond lookup time for in memory), significantly impacting performance for high cardinality queries, as well as errors on the query when latency gets too high due to hitting maximum timeout allowed for a query. For example, each query can read millions of indices for high cardinality queries.

Embodiments described herein provide cardinality-based indexing of time series data by providing a hybrid approach for index caching including a distributed memory cache (e.g., accessible by multiple query nodes) for caching low cardinality indices and a local memory cache (e.g., duplicated onto each query node) for caching high cardinality indices. In this way, query processing latency of high cardinality indices is improved, as the query processing using local memory cache is faster for high cardinality indices than an external distributed memory cache. At the same time, moving a portion of the (e.g., greater than 80%) of the indices to an external distributed cache accessible to the horizontally scaled query nodes improves performance by providing benefits such as cost efficiency and less warm-up time when query nodes are started since the external cache already is warm (loaded with indices). A configurable cardinality threshold is used, whereby cardinality for an index is determined (e.g., at query time when indices are loaded from database for query planning) and is compared to the cardinality threshold. If the cardinality of an index exceeds the cardinality threshold, the index is cached in a local memory cache of the query nodes. Otherwise, if the cardinality of an index does not exceed the cardinality threshold, the index is cached in a distributed memory cache external to and accessible by the query nodes. In accordance with various embodiments, the cardinality threshold for this is determined using multiple iterations of tests optimizing for the following: 1) not hitting the external distributed cache instance's bandwidth bottleneck which the cloud provider enforces limits on by throttling and dropping TCP packets for bandwidth spikes while reading indices; 2) maintaining a worst case query latency of less than three mins time range; and 3) stability of the overall queries with less errors due to timeouts or external cache infrastructure having hot shards (the external cache is clustered with many shards and the hot shards can happen when that shard's nodes have large indices being read from).

As presented above, time series data monitoring systems typically process very large amounts of indices to support high cardinality queries, such that it can be difficult to perform query planning on execution on time series data without encountering latency issues. The cardinality-based tiered index caching of time series data can maintain indices for querying while speeding up query processing and improve the performance and accuracy of query processing, thereby improving the performance and cost efficiency of the overall system. Hence, the embodiments of the described embodiments greatly extend beyond conventional methods of index caching of a time series data monitoring system which are typically are implemented with just one tier (either disk or in memory). Moreover, embodiments of the present invention amount to significantly more than merely using a computer to perform the cardinality-based index caching of time series data indices. Instead, embodiments of the present invention specifically recite a novel process, rooted in computer technology, for providing a hybrid approach to index caching by caching high cardinality indices in a local memory cache and caching low cardinality indices in a distributed memory cache to overcome a problem specifically arising in the realm of monitoring time series data and processing queries on time series data within computer systems.

### Example System for Cardinality-Based Index Caching of Time Series Data

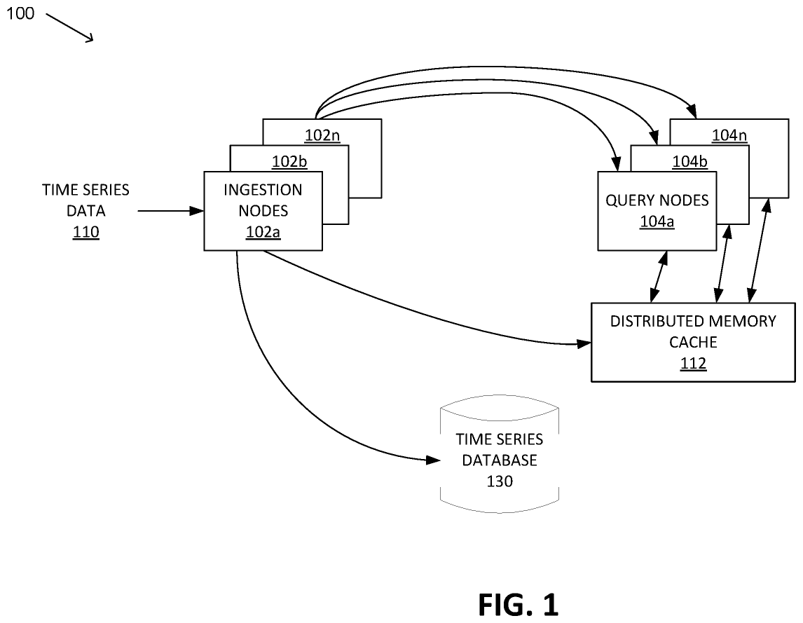

FIG. 1 is a block diagram illustrating an embodiment of a system 100 for managing time series data 110 including ingestion of the time series data 110 and processing queries of time series data 110. System 100 is a distributed system including multiple ingestion nodes 102a through 102n (collectively referred to herein as ingestion nodes 102) and multiple query nodes 104a through 104n (collectively referred to herein as query nodes 104). It should be appreciated that system 100 can include any number of ingestion nodes 102 and any number of query nodes 104. Ingestion nodes 102 and query nodes 104 can be distributed over a network of computing devices in many different configurations. For example, the respective ingestion nodes 102 and query nodes 104 can be implemented where individual nodes independently operate and perform separate ingestion or query operations. In some embodiments, multiple nodes may operate on a particular computing device (e.g., via virtualization), while performing independently of other nodes on the computing device. In other embodiment, many copies of the service (e.g., ingestion or query) are distributed across multiple nodes (e.g., for purposes of reliability and scalability).

Time series data 110 is received at at least one ingestion node 102a through 102n. In some embodiments, time series data includes a numerical measurement of a system or activity that can be collected and stored as a metric (also referred to as a “stream”). For example, one type of metric is a CPU load measured over time. Other examples include service uptime, memory usage, etc. It should be appreciated that metrics can be collected for any type of measurable performance of a system or activity. Operations can be performed on data points in a stream (e.g., sum, average, percentile, etc.) In some instances, the operations can be performed in real time as data points are received. In other instances, the operations can be performed on historical data. Metrics analysis include a variety of use cases including online services (e.g., access to applications), software development, energy, Internet of Things (IoT), financial services (e.g., payment processing), healthcare, manufacturing, retail, operations management, and the like. It should be appreciated that the preceding examples are non-limiting, and that metrics analysis can be utilized in many different types of use cases and applications.

In accordance with some embodiments, a data point in a stream (e.g., in a metric) includes a name, a source, a value, and a time stamp. Optionally, a data point can include one or more tags (e.g., point tags). For example, a data point for a metric may include:
A name—the name of the metric (e.g., CPU.idle, service.uptime).
A source—the name of an application, host, container, instance, or other entity generating the metric (e.g., web_server_1, app1, podId)
A value—the value of the metric (e.g., 99% idle, 1000, 2000)
A timestamp—the timestamp of the metric (e.g., 1418436586000).
One or more point tags (optional)—custom metadata associated with the metric (e.g., region=us_east, environment=prod)

Ingestion nodes 102 are configured to process received data points of time series data 110 for persistence and indexing. In some embodiments, ingestion nodes 102 forward the data points of time series data 110 to time series database 130 for storage. In some embodiments, the data points of time series data 110 are transmitted to an intermediate buffer for handling the storage of the data points at time series database 130. In one embodiment, time series database 130 can store and output time series data, e.g., TS1, TS2, TS3, etc. The data can include times series data, which may be discrete or continuous. For example, the data can include live data fed to a discrete stream, e.g., for a standing query. Continuous sources can include analog output representing a value as a function of time. With respect to processing operations, continuous data may be time sensitive, e.g., reacting to a declared time at which a unit of stream processing is attempted, or a constant, e.g., a 5V signal. Discrete streams can be provided to the processing operations in timestamp order. It should be appreciated that the time series data may be queried in real-time (e.g., by accessing the live data stream) or offline processing (e.g., by accessing the stored time series data).

Ingestion nodes 102 are also configured to process the data points of time series data 110 for generating indices for locating the data points in time series database 130 and storing time series data 110 in time series database 130. During the ingestion of data points, ingestion nodes 102 generate indices or indices updates. Indices (or indices updates) are communicated to one of distributed memory cache 112 or a local memory cache of query nodes 104 based on cardinality of the indices. Cardinality is number of unique values available to be analyzed and queried in an index. Data of high cardinality and high dimensionality is granular data having a high amount of unique values available to be analyzed and queried. For example, in observability, low-cardinality data can help teams examine broad patterns in a service, perhaps by looking at geography, gender, or even cloud providers, and high-cardinality data is a magnifying glass into a service's problems, making it possible to look at outlying events that can help guide troubleshooting efforts. In accordance with the described embodiments, high cardinality indices (e.g., indices with cardinality exceeding a cardinality threshold) are cached at a local memory cache of query nodes 104 and low cardinality indices (e.g., indices with cardinality not exceeding a cardinality threshold) are cached at distributed memory cache 112.

Query nodes 104 are configured to receive and process queries for searching, as well as other operations such as running aggregation functions, on the time series data. In order to plan and perform the searches, query nodes 104 utilize index structures that identify the location of the data points in time series database 130. In some embodiments, high cardinality index structures are stored in a local memory cache of each query node 104 and low cardinality index structures are stored in distributed memory cache 112. In some embodiments, the index structures are refreshed during query planning in the query nodes 104 or updates are seen when an existing metric index has some changes like a tag being added as an example as seen by the ingestion nodes 102. The rate of query node refresh is slower than the rate at which data points are received and index updates are generated.

In some embodiments, ingestion nodes 102 are also configured to forward the indices to at least one of a local memory cache of query nodes 104 and distributed memory cache 112. In some embodiments, ingestion nodes 102 are configured to determine a cardinality of an index and to compare the cardinality to a cardinality threshold. High cardinality indices (e.g., indices with cardinality exceeding a cardinality threshold) are forwarded to a local memory cache of query nodes 104 for caching and low cardinality indices (e.g., indices with cardinality not exceeding a cardinality threshold) are forwarded to distributed memory cache 112 for caching. For instance, in some embodiments, an ingestion node 102 performs a multicast of high cardinality indices to the local memory cache of query nodes 104.

The cardinality-based index caching described herein has the effect that indices with high cardinality are accessed locally at the query node during query processing, reducing latency as compared to accessing a high cardinality at a distributed memory cache over an external connection (e.g., via network routing), while accessing indices with lower cardinality at distributed memory cache 112, where the impacts of communication to an external memory are negligible for low cardinality indices. Thereby, the efficiency of using distributed memory cache 112 to store some indices is achieved, while storing a subset of indices exhibiting high cardinality locally to reduce the impact of reading the large index reduces what would otherwise cause larger than acceptable latency in query response time. In the described embodiments, the cardinality threshold at which high cardinality of an index is determined can be configurable, accounting for changing cardinality of indices and allowing for tuning the cardinality threshold to achieve a desired query response time.

Hence, the embodiments of the described embodiments greatly extend beyond conventional methods of index caching of a time series data monitoring system. Moreover, embodiments of the present invention amount to significantly more than merely using a computer to perform the cardinality-based index caching of time series data indices. Instead, embodiments of the present invention specifically recite a novel process, rooted in computer technology, for providing a hybrid approach to index caching by caching high cardinality indices in a local memory cache and caching low cardinality indices in a distributed memory cache to overcome a problem specifically arising in the realm of monitoring time series data and processing queries on time series data within computer systems.

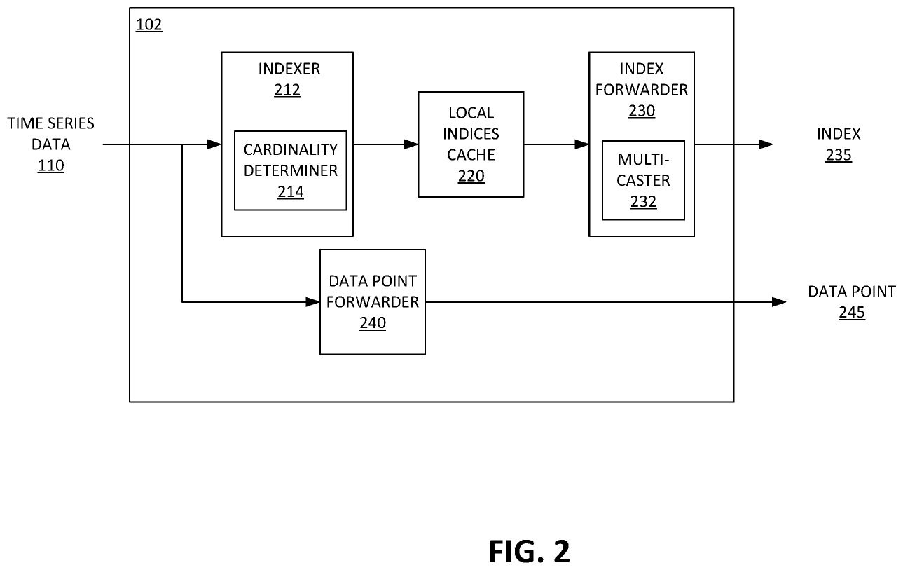

FIG. 2 is a block diagram illustrating an embodiment of an example ingestion node 102 (e.g., one of ingestion nodes 102a through 102n of FIG. 1) for ingesting data points of time series data 110. In one embodiment, ingestion node 102 receives time series data 110, generates an index (or index updates) for data points of time series data 110, and directs the durable storage of the data points 245 and the forwarding of index 235 to a memory cache based on the cardinality of index 235. Ingestion node 102 includes indexer 212, local indices cache 220, index forwarder 230, and data point forwarder 240. It should be appreciated that ingestion node 102 is one node of a plurality of ingestion nodes of a distributed system for managing time series data (e.g., system 100).

In the example shown in FIG. 2, time series data 110 is received. In one embodiment, the time series data 110 comprising data points is received from an application or system. The data points are processed at indexer 212 for generating indices. Time series data 110 is collected and sorted into a plurality of indices to facilitate retrieval of the source time series data 110 (e.g., which data stream to access or which data store to access). It should be appreciated that indexer 212 can generate many different types of indices for facilitating data retrieval. For example, indices can include one or more of a prefix index, a trigram index, a two-tier index, and a three-tier index. A prefix index is an index that includes prefixes of searchable terms. A trigram index is an index that includes three letter combinations of searchable terms. A two-tier index is an index that relates two searchable dimensions (e.g., metric to host or host to metric). A three-tier index is an index that relates three searchable dimensions (e.g., metric to host to point tag or host to metric to point tag).

In some embodiments, indexer 212 includes cardinality determiner 214 for determining a cardinality of an index for use in determining a memory cache in which to cache the index. In one embodiment, cardinality determiner 214 determines a count of items that is the cross multiplication of the combination of the index tier mapping gives (e.g., metric*hosts reported for metric*tags reported for host as an example three tier index), where the count is the cardinality for the index. As data points are processed by ingestion node 102, local indices cache 220 receives index writes generated by indexer 212, where the index writes can include changes to the index.

Index forwarder 230 is configured to communicate index 235 to one of distributed memory cache 112 (e.g., accessible by multiple query nodes) for caching low cardinality indices and a local memory cache (e.g., duplicated onto each query node) of query nodes 104 for caching high cardinality indices. In accordance with the described embodiments, a comparison to a high cardinality threshold is made at ingestion node 102 for determining whether to forward index 235 to distributed memory cache 112 or a local memory cache of query nodes 104. It should be appreciated that this comparison and determination can occur at indexer 212, local indices cache 220, or index forwarder 230, alone or in combination. Index forwarder 230 is configured to forward index 235 to distributed memory cache 112 if the cardinality of index 235 exceeds the cardinality threshold and to forward index 235 to a local memory cache of query nodes 104 if the cardinality of index 235 does not exceed the cardinality threshold.

In one embodiment, index update forwarder includes multicaster 232 for performing the multicasting of index 235 to the local memory cache of query nodes 104. Data point forwarder 240 is configured to forward the data points 245 of time series data 110 to durable storage (e.g., time series database 130 of FIG. 1).

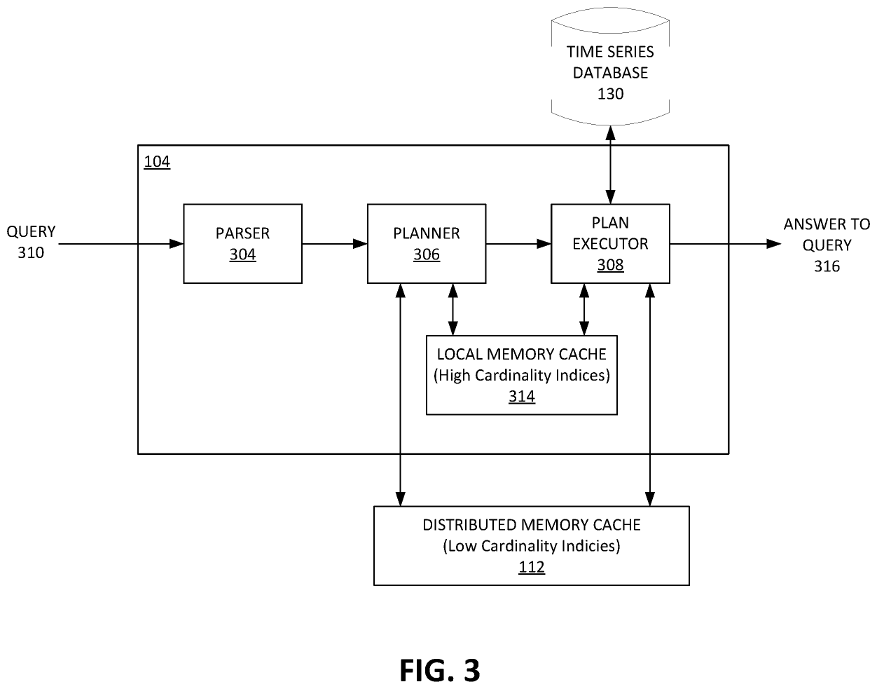

FIG. 3 is a block diagram illustrating an embodiment of an example query node 104 (e.g., one of query nodes 104a through 104n of FIG. 1) for responding to a query 310 regarding time series data. In one embodiment, query node 104 generates a query plan for the time series data based on the query 310. Query node 104 includes parser 304, planner 306, executor 308, and local memory cache 314 for high cardinality indices and distributed memory cache 112 for low cardinality indices. Query node 104 can be implemented by a query execution engine configured to parse a query at parser 304, produce a query execution plan using the indices in both tiers of index cache at planner 306, fetch time series data and run the time series data through processing operations, and write back response including a result to the query at executor 308.

In the example shown in FIG. 3, a query 310 is received. In one embodiment, the query 310 is provided by a user via a client. Time series data is provided by a time series database 130. Query 310 is received for searching the time series data. A query can include elements that define searchable parameters of the time series data. For example, the query can include elements defining terms related to metrics, sources, values, timestamps, and/or point tags for isolating and returning relevant results. The parser 304 receives a query 310 and parses the query for a predicate (e.g., elements and operators).

The planner 306 receives the parsed elements and operators of query 310 and generates a query plan for retrieval of relevant time series data that resolves the query 310. The planner 306 determines the time series matching the query pattern and filters given by consulting the indices in the indices cache to retrieve a result of the query 310.

In operation, query node 104 receives a query. Planner 306 generates a query plan for determining what to retrieve from time series databases 130 based on the query 310. For example, planner 306 determines how many scans to make on the time series database(s) by accessing indices in local memory cache 314 and/or in distributed memory cache 112. In accordance with the described embodiments, indices exhibiting high cardinality are cached at local memory cache 314 and indices that do not exhibit high cardinality are cached at distributed memory cache 112.

Planner 306 is configured to determine whether an index is accessed at local memory cache 314 or distributed memory cache 112 (e.g., via a lookup table). In one embodiment, planner 306 first accesses local memory cache 314 to access a desired index and, if the desired index is not in local memory cache 314, planner 306 then accesses distributed memory cache 112 to access the desired index. In another embodiment, planner 306 first accesses distributed memory cache 112 to access a desired index and, if the desired index is not in local memory cache 314, planner 306 then accesses local memory cache 314 to access the desired index. The planner 306 then hands off commands (e.g., a query plan) to executor 308 to perform an execution phase, e.g., beginning execution of the query 310. The executor 308 then outputs an answer 316 to the query by retrieving the time series data and running aggregation function on them. Although shown as a single stream, the answer 316 to the query can include one or more streams depending on the aggregation that is done.

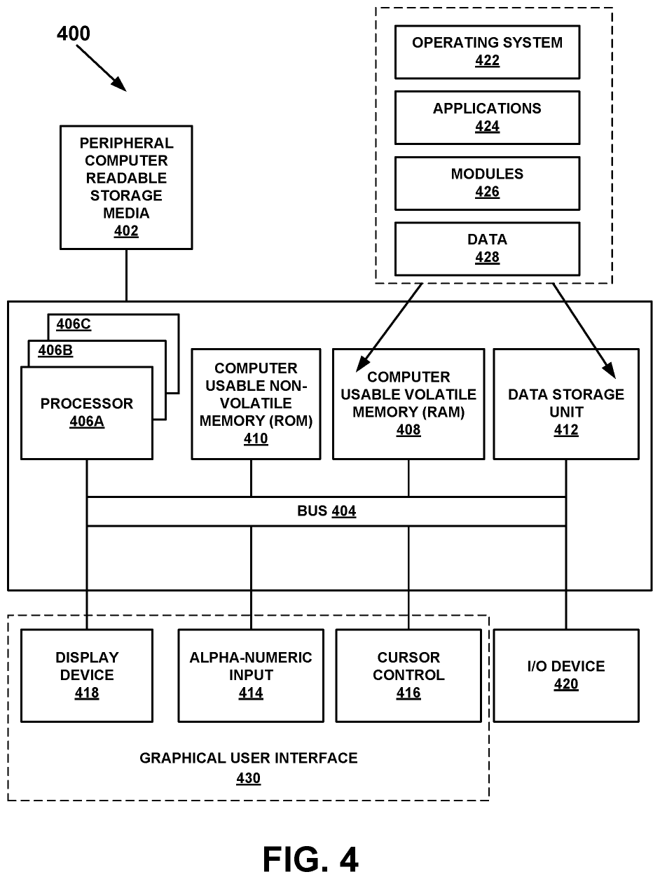

FIG. 4 is a block diagram of an example computer system 400 upon which embodiments of the present invention can be implemented. FIG. 4 illustrates one example of a type of computer system 400 (e.g., a computer system) that can be used in accordance with or to implement various embodiments which are discussed herein.

It is appreciated that computer system 400 of FIG. 4 is only an example and that embodiments as described herein can operate on or within a number of different computer systems including, but not limited to, general purpose networked computer systems, embedded computer systems, mobile electronic devices, smart phones, server devices, client devices, various intermediate devices/nodes, standalone computer systems, media centers, handheld computer systems, multi-media devices, and the like. In some embodiments, computer system 400 of FIG. 4 is well adapted to having peripheral tangible computer-readable storage media 402 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

Computer system 400 of FIG. 4 includes an address/data bus 404 for communicating information, and a processor 406A coupled with bus 404 for processing information and instructions. As depicted in FIG. 4, computer system 400 is also well suited to a multi-processor environment in which a plurality of processors 406A, 406B, and 406C are present. Conversely, computer system 400 is also well suited to having a single processor such as, for example, processor 406A. Processors 406A, 406B, and 406C may be any of various types of microprocessors. Computer system 400 also includes data storage features such as a computer usable volatile memory 408, e.g., random access memory (RAM), coupled with bus 404 for storing information and instructions for processors 406A, 406B, and 406C. Computer system 400 also includes computer usable non-volatile memory 410, e.g., read only memory (ROM), coupled with bus 404 for storing static information and instructions for processors 406A, 406B, and 406C. Also present in computer system 400 is a data storage unit 412 (e.g., a magnetic or optical disc and disc drive) coupled with bus 404 for storing information and instructions. Computer system 400 also includes an alphanumeric input device 414 including alphanumeric and function keys coupled with bus 404 for communicating information and command selections to processor 406A or processors 406A, 406B, and 406C. Computer system 400 also includes an cursor control device 416 coupled with bus 404 for communicating user input information and command selections to processor 406A or processors 406A, 406B, and 406C. In one embodiment, computer system 400 also includes a display device 418 coupled with bus 404 for displaying information.

Referring still to FIG. 4, display device 418 of FIG. 4 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 416 allows the computer user to dynamically signal the movement of a visible symbol (cursor) on a display screen of display device 418 and indicate user selections of selectable items displayed on display device 418. Many implementations of cursor control device 416 are known in the art including a trackball, mouse, touch pad, touch screen, joystick or special keys on alphanumeric input device 414 capable of signaling movement of a given direction or manner of displacement. Alternatively, it will be appreciated that a cursor can be directed and/or activated via input from alphanumeric input device 414 using special keys and key sequence commands. Computer system 400 is also well suited to having a cursor directed by other means such as, for example, voice commands. In various embodiments, alphanumeric input device 414, cursor control device 416, and display device 418, or any combination thereof (e.g., user interface selection devices), may collectively operate to provide a graphical user interface (GUI) 430 under the direction of a processor (e.g., processor 406A or processors 406A, 406B, and 406C). GUI 430 allows user to interact with computer system 400 through graphical representations presented on display device 418 by interacting with alphanumeric input device 414 and/or cursor control device 416.

Computer system 400 also includes an I/O device 420 for coupling computer system 400 with external entities. For example, in one embodiment, I/O device 420 is a modem for enabling wired or wireless communications between computer system 400 and an external network such as, but not limited to, the Internet. In one embodiment, I/O device 420 includes a transmitter. Computer system 400 may communicate with a network by transmitting data via I/O device 420.

Referring still to FIG. 4, various other components are depicted for computer system 400. Specifically, when present, an operating system 422, applications 424, modules 426, and data 428 are shown as typically residing in one or some combination of computer usable volatile memory 408 (e.g., RAM), computer usable non-volatile memory 410 (e.g., ROM), and data storage unit 412. In some embodiments, all or portions of various embodiments described herein are stored, for example, as an application 424 and/or module 426 in memory locations within RAM 408, computer-readable storage media within data storage unit 412, peripheral computer-readable storage media 402, and/or other tangible computer-readable storage media.

### Example Methods of Operation

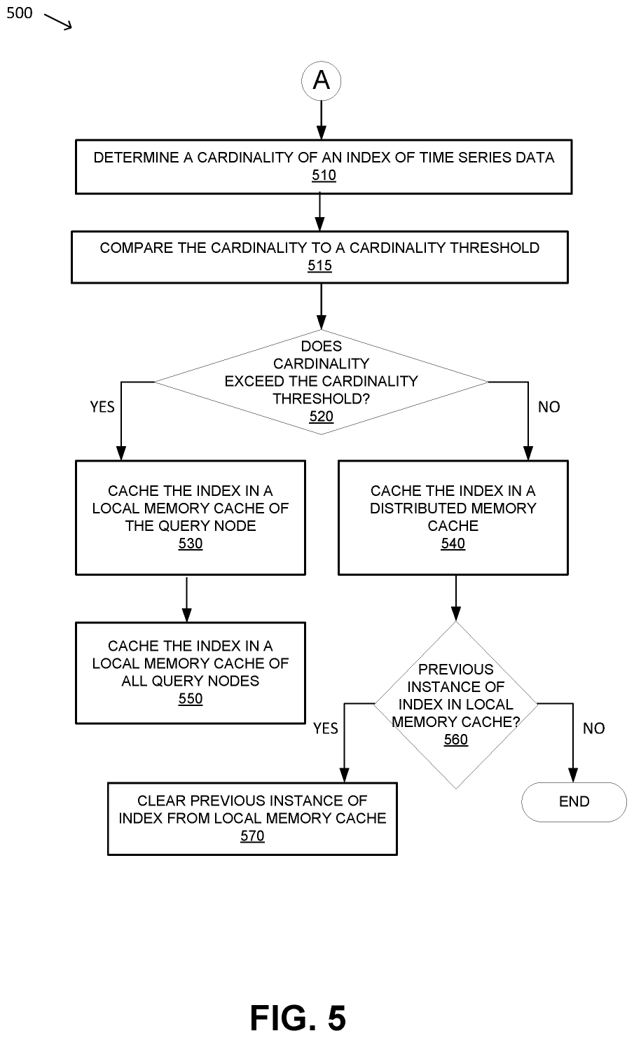

The following discussion sets forth in detail the operation of some example methods of operation of embodiments. With reference to FIGS. 5 through 7, flow diagrams 500, 600, and 700 illustrate example procedures used by various embodiments. The flow diagrams 500, 600, and 700 include some procedures that, in various embodiments, are carried out by a processor under the control of computer-readable and computer-executable instructions. In this fashion, procedures described herein and in conjunction with the flow diagrams are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments (e.g., computer system 400). The computer-readable and computer-executable instructions, which reside on tangible computer readable storage media, are used to control or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in the flow diagram, such procedures are examples. That is, embodiments are well suited to performing various other procedures or variations of the procedures recited in the flow diagram. Likewise, in some embodiments, the procedures in flow diagrams 500, 600, and 700 may be performed in an order different than presented and/or not all of the procedures described in flow diagrams 500, 600, and 700 may be performed. It is further appreciated that procedures described in flow diagrams 500, 600, and 700 may be implemented in hardware, or a combination of hardware with firmware and/or software provided by computer system 400.

FIG. 5 depicts an example flow diagram 500 of a process for cardinality-based index caching of time series data, according to various embodiments. At procedure 510 of flow diagram 500, a cardinality of an index of a time series data monitoring system is determined. In one embodiment, the cardinality is a number of time series data associated with the index. At procedure 515, the cardinality of the index is compared to a cardinality threshold. At procedure 520, it is determined whether the cardinality exceeds the cardinality threshold. Responsive to determining that the cardinality of the index exceeds the cardinality threshold, as shown at procedure 530, the index is cached in a local memory cache of a query node of the times series data monitoring system. In one embodiment, as shown at procedure 550, responsive to caching the index in the local memory cache of the query node, the index in the local memory cache of all query nodes query nodes of the time series data monitoring system.

Responsive to determining that the cardinality of the index does not exceed the cardinality threshold, as shown at procedure 540, the index is cached in a distributed memory cache of the times series data monitoring system. In one embodiment, as shown at procedure 560, it is determined whether a previous instance of the index is in the local memory cache. Responsive to determining that the previous instance of the index is in the local memory cache, as shown at procedure 570, the previous instance of the index is cleared from the local memory cache. Responsive to determining that the previous instance of the index is not in the local memory cache, flow diagram 500 ends.

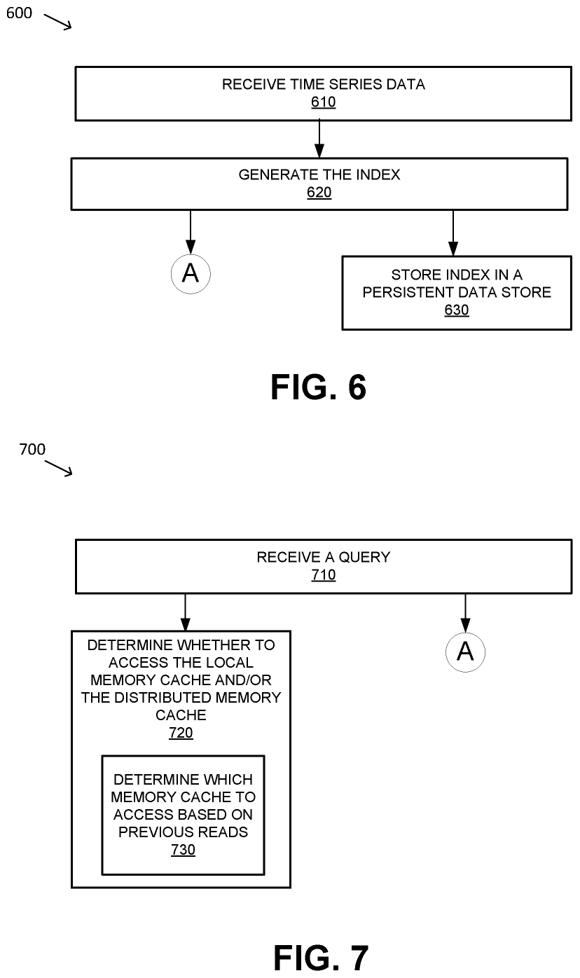

With reference to FIG. 6, and in accordance with some embodiments, example flow diagram 600 illustrates additional procedures of a process for cardinality-based index caching of time series data, according to various embodiments. At procedure 610 of flow diagram 600, time series data is received at an ingestion node of the time series data monitoring system. At procedure 620, the index is generated at the ingestion node based on the time series data. In one embodiment, as shown at procedure 630, the index is stored in a persistent data store of the time series data monitoring system. In one embodiment, flow diagram 600 proceeds to procedure 510 of flow diagram 500, such that the determination of the cardinality of the index is performed responsive to the generating the index at the ingestion node.

With reference to FIG. 7, and in accordance with some embodiments, example flow diagram 700 illustrates additional procedures of a process for cardinality-based index caching of time series data, according to various embodiments. At procedure 710 of flow diagram 700, a query is received at a query node. In one embodiment, as shown at procedure 720, it is determined whether to access the index at the local memory cache or the distributed memory cache. In one embodiment, as shown at procedure 730, the determination whether to access the index at the local memory cache or the distributed memory cache is based on previous reads of the index for historical queries. In one embodiment, flow diagram 700 proceeds to procedure 510 of flow diagram 500, such that the determination of the cardinality of the index is performed responsive to the receiving the query at a query node.

It is noted that any of the procedures, stated above, regarding the flow diagrams of FIG. 5 may be implemented in hardware, or a combination of hardware with firmware and/or software. For example, any of the procedures are implemented by a processor(s) of a cloud environment and/or a computing environment.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Many variations, modifications, additions, and improvements are possible, regardless the degree of virtualization. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A computer-implemented method for cardinality-based index caching of time series data, the method comprising:
determining a cardinality of an index of a time series data monitoring system;
comparing the cardinality of the index to a cardinality threshold;
responsive to determining that the cardinality of the index exceeds the cardinality threshold, caching the index in a local memory cache of a query node of the times series data monitoring system; and
responsive to determining that the cardinality of the index does not exceed the cardinality threshold, caching the index in a distributed memory cache of the times series data monitoring system.

2. The computer-implemented method of claim 1, further comprising:
receiving time series data at an ingestion node of the time series data monitoring system; and
generating the index at the ingestion node based on the time series data.

3. The computer-implemented method of claim 2, wherein the determining the cardinality of the index is performed responsive to the generating the index at the ingestion node.

4. The computer-implemented method of claim 1, further comprising:
responsive to determining that the cardinality of the index does not exceed the cardinality threshold, determining whether a previous instance of the index is in the local memory cache; and
responsive to determining that the previous instance of the index is in the local memory cache, clearing the previous instance of the index from the local memory cache.

5. The computer-implemented method of claim 1, wherein the times series data monitoring system comprises a plurality of query nodes, the method further comprising:
responsive to caching the index in the local memory cache of the query node, caching the index in the local memory cache of the plurality of query nodes.

6. The computer-implemented method of claim 5, wherein the distributed memory cache is accessible by the plurality of query nodes.

7. The computer-implemented method of claim 1, further comprising:
responsive to receiving a query at the query node, determining whether to access the index at the local memory cache or the distributed memory cache.

8. The computer-implemented method of claim 7, wherein the determining whether to access the index at the local memory cache or the distributed memory cache comprises:
determining whether to access the index at the local memory cache or the distributed memory cache based on previous reads of the index for historical queries.

9. The computer-implemented method of claim 7, wherein the determining the cardinality of the index is performed responsive to the receiving the query at the query node.

10. The computer-implemented method of claim 1, further comprising:
storing the index in a persistent data store of the time series data monitoring system.

11. The computer-implemented method of claim 1, wherein the cardinality is a number of time series data associated with the index.

12. A time series data monitoring system capable of cardinality-based index caching of time series data, the time series data monitoring system comprising:
a plurality of nodes comprising a plurality of ingestion nodes and a plurality of query nodes, each node of the plurality of nodes comprising a data storage unit and a processor communicatively coupled with the data storage unit, a node of the plurality of nodes is configured to:
determine a cardinality of an index of the time series data monitoring system;
compare the cardinality of the index to a cardinality threshold;
responsive to determining that the cardinality of the index exceeds the cardinality threshold, cache the index in a local memory cache of the plurality of query nodes; and
responsive to determining that the cardinality of the index does not exceed the cardinality threshold, cache the index in a distributed memory cache of the times series data monitoring system.

13. The time series data monitoring system of claim 12, wherein the node is an ingestion node, the node further configured to:
receive time series data; and
generate the index based on the time series data.

14. The time series data monitoring system of claim 13, wherein determining the cardinality of the index is performed responsive to generating the index.

15. The time series data monitoring system of claim 12, wherein the node is further configured to:
responsive to determining that the cardinality of the index does not exceed the cardinality threshold, determine whether a previous instance of the index is in the local memory cache of the plurality of query nodes; and
responsive to determining that the previous instance of the index is in the local memory cache of the plurality of query nodes, clear the previous instance of the index from the local memory cache of the plurality of query nodes.

16. The time series data monitoring system of claim 12, wherein the node is query node, the node further configured to:
receive a query; and
responsive to receiving the query, determine whether to access the index at the local memory cache or the distributed memory cache.

17. The time series data monitoring system of claim 16, the node further configured to:
determine whether to access the index at the local memory cache or the distributed memory cache based on previous reads of the index for historical queries.

18. The time series data monitoring system of claim 16, wherein determining the cardinality of the index is performed responsive to the receiving the query at the query node.

19. The time series data monitoring system of claim 12, the node further configured to:
store the index in a persistent data store of the time series data monitoring system.

20. A non-transitory computer readable storage medium having computer readable program code stored thereon for causing a computer system to perform a method for cardinality-based index caching of time series data, the method comprising:
determining a cardinality of an index of a time series data monitoring system;
comparing the cardinality of the index to a cardinality threshold;
responsive to determining that the cardinality of the index exceeds the cardinality threshold, caching the index in a local memory cache of a query node of the times series data monitoring system; and
responsive to determining that the cardinality of the index does not exceed the cardinality threshold, caching the index in a distributed memory cache of the times series data monitoring system.
